(19) United States
(12) Patent Application Publication
(10) Pub. No.: US 2007/0028285 A1
(43) Pub. Date: Feb. 1, 2007

(54) Using common-sense knowledge to characterize multimedia content

(76) Inventor: Elmo Marcus Attila Diederiks, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/571,629

(22) PCT Filed: Aug. 30, 2004
(86) PCT No.: PCT/IB04/51597

§ 371 Date: Mar. 14, 2006

(30) Foreign Application Priority Data
Sep. 16, 2003 (EP) 03103395.4

(51) Int. Cl. H04N 7/16; G06F 3/00; G06F 15/00; G06F 17/00; G06F 9/00

(52) U.S. Cl. 725/135; 715/500; 715/704

(57) ABSTRACT

The present invention relates to a method of processing multimedia content, such as audio or video content, wherein the method comprises the steps of: receiving a data signal comprising said multimedia content; identifying predefined features in the received multimedia content; determining characteristics of the received multimedia content on the basis of a predefined link between one or more of said identified predefined features and one or more characteristics, wherein the links between said features and said characteristics have been made on the basis of real-world knowledge. A parameter can be generated on the basis of the characteristics and may be used for a number of purposes, such as e.g. keyword searches in content, or content rendering based on characteristics and language detection.

The present invention relates to a method of processing multimedia content, such as audio or video content. The invention also relates to an apparatus for processing multimedia content, such as audio or video content. Furthermore, the invention relates to a data signal describing multimedia content wherein the data signal further comprises meta-data. The invention further relates to a storage medium comprising a data signal describing multimedia content wherein the data signal further comprises meta-data.

As the number of channels available to television viewers has increased, along with the diversity of the programming content available on such channels, it has become increasingly challenging for television viewers to identify television programs of interest.

Historically, television viewers identified television programs of interest by analyzing printed television program guides. Typically, such printed television program guides contained grids listing the available television programs by time and date, channel and title. As the number of television programs has increased, it has become increasingly difficult to effectively identify desirable television programs using such printed guides.

More recently, television program guides have become available in an electronic format, often referred to as electronic program guides (EPGs). Like printed television program guides, EPGs contain grids listing the available television programs by time and date, channel and title. Some EPGs, however, allow television viewers to sort or search the available television programs in accordance with personalized preferences. In addition, EPGs allow on-screen presentation of the available television programs.

While EPGs allow viewers to identify desirable programs more efficiently than conventional printed guides, they suffer from a number of limitations, which, if overcome, may further enhance the ability of viewers to identify desirable programs.

In general, there are recommender and content management systems which, based on meta-data in the multimedia signal being e.g. a video and/or an audio signal, define properties of the content and thereby give the viewer or listeners further possibilities of identifying specific content. Recommender and content management systems provide added value only if proper meta-data is available. The types of meta-data are numerous, but one type that is currently lacking is that of an affective or emotive description of the content or parts of the content (for instance, scenes or parts of music). Although the MPEG 7 standard foresees the importance of such meta-data, by providing a meta-data tag that is supposed to contain such affective information, it has not been suggested how to determine the information to the tag. One of the reasons for the absence of this kind of information is that a standardized categorization does not exist and labeling by hand is a time-consuming activity. Furthermore, traditional feature extraction (or signal analysis) does not provide such information, because it is not clearly present in the content itself.

It is an object of the present invention to provide a solution to the above-mentioned problems and find a method of determining an affective and emotive description of multimedia content.

This is obtained by a method of processing multimedia content, such as audio or video content, wherein the method comprises the steps of:

receiving a data signal comprising said multimedia content;

identifying predefined features in the received multimedia content;

determining characteristics of the received multimedia content on the basis of a predefined link between one or more of said identified predefined features and one or more characteristics, wherein the links between said features and said characteristics have been made on the basis of real-world knowledge.

A parameter can be generated, which is based on the characteristics and may be used for a number of purposes, such as e.g. keyword searches in content, content rendering based on characteristics and language detection. In one embodiment, characteristics may be determined in real-time during presentation of the content; alternatively, the characteristics may be pre-added to the content. The characteristics based on real-world knowledge may be ambience of the content, such as sadness, happiness, anger, etc. Real-world knowledge includes common-sense reasoning, as well as general knowledge. Therefore, based on detected content in the multimedia content, the real world knowledge including common sense or general knowledge can be used to link the content to the characteristics. The characteristics and the content relations may be stored as a rule-base or as an association map. It has previously been described how real-world knowledge can be used for detecting characteristics of text. This can be found in the article by H. Liu, H. Lieberman, T. Selker (2003), A Model of Textual Affect Sensing using Real-World Knowledge, IUI 2003, January 2003, Miami, Fla., USA.

In a specific embodiment, the predefined features in the multimedia content are predefined colors in a video signal. The predefined colors may either be a predefined range of colors or they may be specific predefined colors. The colors used in a scene are often used to communicate with the viewer; this may be e.g. ambience or culture.

In another specific embodiment, the predefined features in the multimedia content are predefined sound elements in an audio signal. The sound or music used e.g. during a scene is often used to communicate with the viewer and may express e.g. sadness, horror, action, love; besides these ambience characteristics, it may also be culture.

In a specific embodiment, the method further comprises the steps of presenting the content of the multimedia signal in accordance with the determined characteristics. The presentation of the multimedia content may be further optimized during presentation; e.g. by dimming the light in a happy scene or enhancing a color in a specific cultural environment.

In an embodiment, the determined characteristics are added to the multimedia signal as meta-data. The signal may e.g. be stored or broadcast, comprising the meta-data, and the receiver or reader does not have to determine the data in order to use them.

In a specific embodiment, the determined characteristics are the ambience of the received multimedia content. Ambience may e.g. be the atmosphere of an environment and the ambience of multimedia content is relatively simple to determine on the basis of predefined features in multimedia content. The specific colors or sounds are often used to amplify the ambience of the multimedia content for the viewer or listener; as mentioned above, such ambience may e.g. be sadness, horror, action, love.

The invention further relates to an apparatus for processing multimedia content, such as audio or video content, wherein the apparatus comprises:

a receiver adapted to receive a data signal describing said multimedia content;

a processor adapted to identify predefined features in the received multimedia content;

a data base comprising links between one or more of said identified predefined features and one or more characteristics, wherein the links between said features and said characteristics have been made on the basis of real-world knowledge;

a processor adapted to determine the characteristics of the received multimedia content on the basis of the content in said database.

In a specific embodiment, the apparatus is adapted to read the content of a storage medium comprising multimedia content, wherein the receiver is adapted to receive a data signal describing said multimedia content, where said data signal has been read from said storage medium.

The invention also relates to a data signal describing multimedia content, wherein the data signal further comprises meta-data, said meta-data defining characteristics of said multimedia content, and wherein the characteristics have been determined by identifying predefined features in said multimedia content and by determining the characteristics of the received multimedia content on the basis of a predefined link between one or more of said identified predefined features and one or more characteristics, wherein the links between said features and said characteristics have been made on the basis of real-world knowledge.

The invention also relates to an apparatus for processing a data signal as defined hereinbefore, wherein the apparatus comprises:

means for receiving a user request comprising an identification of characteristics of multimedia content,

means for processing said data signal by searching for meta-data defining characteristics similar to the characteristics identified in said user request,

means for presenting the multimedia content in the data signal for the user if the meta-data in said data signal defines characteristics similar to the characteristics identified by said user request.

The apparatus may also be referred to as a content recommender, and by using the meta-data for recommending content it is possible to recommend in accordance with the real-world knowledge-based characteristics defined by the meta-data. This increases the quality of a recommender system by making it possible to recommend in accordance with e.g. the ambience of the multimedia content.

The invention also relates to a storage medium comprising data describing multimedia content, wherein the data further comprises meta-data, said meta-data defining characteristics of said multimedia content, and wherein the characteristics have been determined by identifying predefined features in said multimedia content and by determining the characteristics of the received multimedia content on the basis of a predefined link between one or more of said identified predefined features and one or more characteristics, wherein the links between said features and said characteristics have been made on the basis of real-world knowledge.

Preferred embodiments of the invention will be described hereinafter with reference to the Figures, wherein

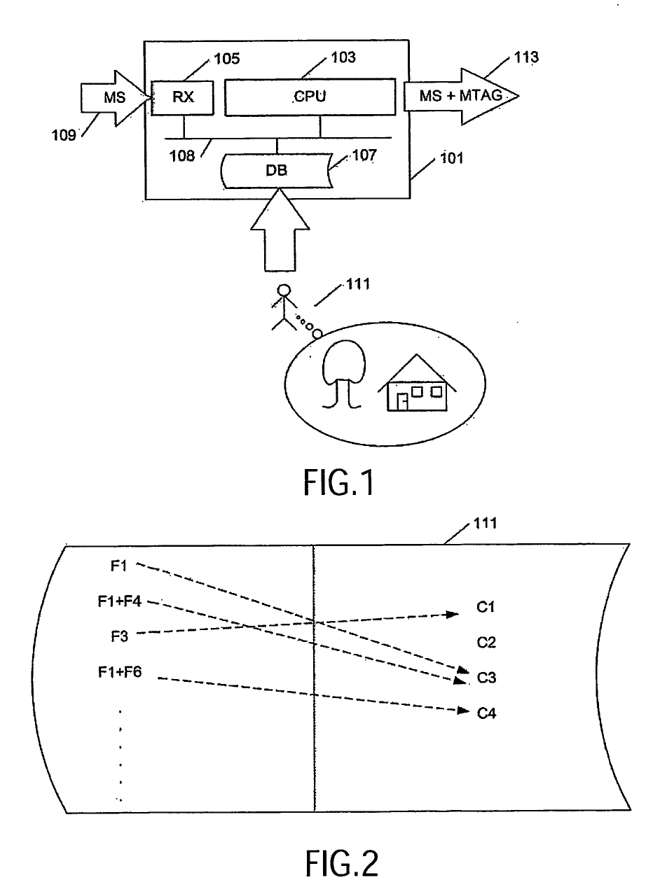

FIG. 1 illustrates a system according to the present invention;

FIG. 2 illustrates a database comprising links between predefined features and characteristics;

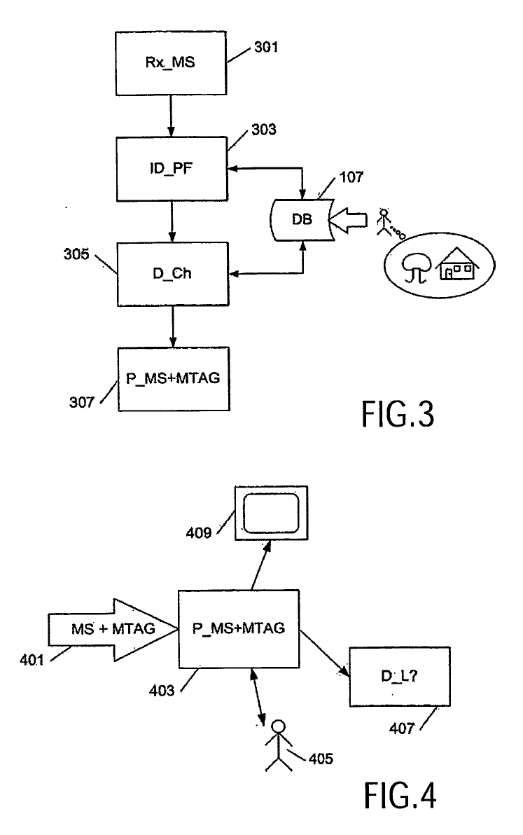

FIG. 3 illustrates a method of determining characteristics in multimedia content according to the present invention;

FIG. 4 illustrates different types of processing and usage of a multimedia signal comprising meta-tags according to the present invention.

In FIG. 1, a system 101 according to the present invention is illustrated, which system comprises a central processor unit (CPU) 103, a receiver 105, and a database 107 which communicates via a communication bus 108. The receiver 105 can receive a multimedia signal (MS) 109 comprising multimedia content data such as audio and/or video data Such multimedia data may e.g. be received from a device adapted to read multimedia content from a storage medium comprising the multimedia data, such as a DVD or VCR. Furthermore, the signal may also be received from a receiver adapted to receive broadcast multimedia content, e.g. in a digital TV signal. The database 107 comprises links between predefined features in multimedia content and corresponding characteristics, wherein the links between the features and the characteristics are based on real-world knowledge 111. The CPU 103 running a detection algorithm then uses the contents of the database 107 to determine characteristics of the multimedia content. The detection algorithm may comprise the steps of detecting color elements and/or audio elements in the multimedia content, e.g. by using an audio or video detector. A number of methods of detecting color or audio elements in multimedia content are available, and in order to obtain a higher level of information from the multimedia content, these methods may be combined. One method of detecting color elements is by extracting average color from the pixel information, which can be done in the RGB color space by using the RGB value of each pixel and then calculating the average RGB value of the whole screen or of regions or objects in the screen. Audio elements may be detected, for example, by detecting zero-crossings in the audio waveform, which may be used for determining the dynamics or tempo of the audio. After having detected features in the multimedia content, the algorithm searches for the detected features in the database 107 and, based on the link from the feature to the characteristics, the algorithm generates a new signal 113 comprising both the multimedia signal (MS) and a meta-tag (MTAG) identifying the characteristics that can be generated.

In FIG. 2, the contents of the database 111 are illustrated, where different predefined features (F1 , F2, F3 ,F4) or combinations of features are linked to different characteristics (C1, C2, C3 C4). The predefined features in the multimedia content may be specific colors, specific types of colors, or specific combinations of colors. Furthermore, the features may be specific sounds or a combination of sound and colors. More generally, the features may be any kind of information about the multimedia content relating to one or more video scenes, video frames and/or a sound or a combination of sounds. These predefined characteristics are then defined and linked to characteristics in the database. According to the general idea of the invention, this linking is based on real-world knowledge.

Multimedia content features and characteristics may be linked according to real-world knowledge in that characteristics such as happiness and holidays are linked to the predefined features: warm colors, blue skies and Latin music in the multimedia content. Another example of linking features of the content with characteristics on the basis of real-world knowledge may be the following scenario. In some countries (culture-dependent) people in mourning may dress in black clothes, which is associated with sadness. Therefore a characteristic such as sadness may be determined when the multimedia content comprises a scene featuring people wearing black clothes; this decision might have to be made in connection with another decision based on a real-world knowledge link between a feature and a specific culture or type of culture, e.g. in a certain country or area. In audio, similar operations can be performed on the basis of e.g. the speed of the different tones in a tune, where a slow tune is one feature which might imply a scene in which people are being intimate or at least a non-action scene, whereas a very fast tune may mean that it is a scene involving a lot of action or at least not a calm scene.

FIG. 3 illustrates how the characteristics are detected in multimedia content. First, in 301, the multimedia signal comprising the multimedia content is received by the system; this may e.g. be received from an internal multimedia content reader/receiver or from an externally connected multimedia content reader/receiver. In 303, predefined features are searched for and identified in the multimedia content on the basis of the content of the database 107, e.g. by searching for specific colors and/or specific sound in the content identified in the database 107.

Next, in 305, the characteristic of the content is determined on the basis of the identified features and their corresponding link in the database 107. Finally, in 307, the characteristics of the multimedia content have been determined and the content can be processed, using the additional determined information.

FIG. 4 shows examples of different methods of processing or using multimedia content comprising the additional determined information. In the Figure, the multimedia signal 401 comprising the meta-tag is illustrated as input to a processing device 403. In the example 405, a user may search for specific multimedia content on the basis of the characteristics of the content, e.g. he may search for sad content or action content, or a combination of these characteristics. In 407, the characteristics are used to determine culture and country and thereby determine the language, which information may be used e.g. when converting speech to text or when subtitling video content. In 409, the information is used when presenting the content, where the meta-data may be used when rendering the content, e.g. by fading the light in a scene or by enhancing specific tones in audio, depending on the characteristics.

The processing may be performed in a content recommender system, which can recommend specific multimedia content on the basis of the characteristics of the multimedia content. In an example, the multimedia content may be video content, e.g. from a source such as a DVD on which the data comprising the multimedia content and the meta-data are stored. Alternatively, only the multimedia content may be stored on the DVD and the meta-data generation as described above is performed before the content recommender system processes the content. The content recommender system comprises a device for reading the data on the DVD, and the meta-data can then be used to present specific parts of the multimedia content on the basis of the characteristics identified in the meta-data. More specifically, a user using an input device such as a keyboard or remote control may specify that he only wants to see the happy parts in the content. Then the recommender system searches for the happy characteristics in the meta-data and presents the content with meta-data identifying the happy characteristic. Alternatively, the recommender may also initially scan the data on the DVD and rate the content on the basis of the detected meta-data, e.g. if a predefined percentage of the content relates to characteristics such as sadness, violence or erotic scenes, the multimedia content should be rated as being unsuitable for children.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb ‘comprise’ and its conjugations does not exclude the presence of elements or steps other than those stated in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of processing multimedia content, wherein the method comprises the steps of:
receiving (301) a data signal (109) comprising said multimedia content;
identifying (303) predefined features (F1, F1+F4, F3, F1+F6) in the received multimedia content;
determining (305) characteristics of the received multimedia content on the basis of a predefined link between one or more of said identified predefined features (F1, F1+F4, F3, F1+F6) and one or more characteristics (C1, C2, C3, C4), wherein the links between said features and said characteristics have been made on the basis of real-world knowledge (111).

2. A method as claimed in claim 1, wherein the predefined features in the multimedia content are predefined colors in a video signal.

3. A method as claimed in claim 1, wherein the predefined features in the multimedia content are predefined sound elements in an audio signal.

4. A method as claimed in claim 1, wherein the method further comprises the step of presenting the content of the multimedia signal in accordance with the determined characteristics.

5. A method as claimed in claim 1, wherein the determined characteristics are added to the multimedia signal as meta-data.

6. A method as claimed in claim 1, wherein the determined characteristics are the ambience of the received multimedia content.

7. An apparatus for processing multimedia content, such as audio or video content, wherein the apparatus comprises:
a receiver (105) adapted to receive a data signal (109) describing said multimedia content;
a processor (103) adapted to identify predefined features (F1, F1+F4, F3, F1+F6) in the received multimedia content;
a database (11) comprising links between one or more of said identified predefined features (F1, F1+F4, F3, F1+F6) and one or more characteristics (C1, C2, C3, C4), wherein the links between said features and said characteristics have been made on the basis of real-world knowledge (111);
a processor (103) adapted to determine the characteristics of the received multimedia content on the basis of the content in said database.

8. An apparatus as claimed in claim 7, wherein the apparatus is adapted to read the content of a storage medium comprising multimedia content and wherein the receiver is adapted to receive a data signal describing said multimedia content, where said data signal has been read from said storage medium.

9. A data signal describing multimedia content wherein the data signal further comprises meta-data, said meta-data defining characteristics of said multimedia content, and wherein the characteristics have been determined by identifying predefined features in said multimedia content and by determining the characteristics of the received multimedia content on the basis of a predefined link between one or more of said identified predefined features and one or more characteristics, wherein the links between said features and said characteristics have been made on the basis of real-world knowledge.

10. An apparatus for processing a data signal as claimed in claim 9, wherein the apparatus comprises:
means for receiving a user request comprising an identification of characteristics of multimedia content,
means for processing said data signal by searching for meta-data defining characteristics similar to the characteristics identified in said user request,
means for presenting the multimedia content in the data signal for the user if the meta-data in said data signal defines characteristics similar to the characteristics identified by said user request.

11. A storage medium comprising data describing multimedia content, wherein the data further comprises meta-data, said meta-data defining characteristics of said multimedia content, and wherein the characteristics have been determined by identifying predefined features in said multimedia content and by determining the characteristics of the received multimedia content on the basis of a predefined link between one or more of said identified predefined features and one or more characteristics, wherein the links between said features and said characteristics have been made on the basis of real-world knowledge.
